(19) United States
(12) Patent Application Publication
(10) Pub. No.: US 2020/0326060 A1
(43) Pub. Date: Oct. 15, 2020

(54) VERSATILE POSITIONABLE TASK LAMP

(71) Applicant: Christopher Fitch, Arlington, MA (US)

(72) Inventor: Christopher Fitch, Arlington, MA (US)

(21) Appl. No.: 16/845,635

(22) Filed: Apr. 10, 2020

Related U.S. Application Data
(60) Provisional application No. 62/833,779, filed on Apr. 14, 2019.

(51) Int. Cl. F21V 21/28; F21V 21/06

(52) U.S. Cl. CPC F21V 21/28; F21V 21/145; F21V 21/06

(57) ABSTRACT

A versatile positionable task lamp includes a base, a first arm extending from the base and rotatable about its own axis, a second arm connected with the first arm by a first joint which enables the second arm to rotate about its own axis and rotate about an axis of the first joint, a third arm connected with the second arm by a second joint which enables the third arm to rotate about its own axis and rotate about an axis of the second joint, a lighting element connected with the third arm by a third joint which enables the lighting element to rotate about an axis of the third joint, and a plurality of counterweights disposed on the second and third arms in a way that two masses respectively extending from two opposite sides of anyone of the first and second joints are counterweighted by each other.

### BACKGROUND OF THE INVENTION

### 1. Field of the Invention

The present invention relates generally to lamps and more particularly, to a versatile positionable task lamp.

### 2. Description of the Related Art

The field of task lighting is wide and deep. From dental offices to libraries, people need to see what they are doing or reading, and many solutions have been offered to put light where it is needed. Furthermore, the comfort and convenience of the user is important, and so ease of use should be maximized as well as comfort for the eyes.

There are many examples of task lamps with articulated positioning arms. Being able to position the light to shine on the task at hand is an important utilitarian element in each of these examples. This feature requires the use of joints along the arm structure used to support the lighting element. It also requires a means for counteracting the force of gravity on each section of the articulated arm so that the joints can be allowed to be loose enough to afford easy movement. Although there are some examples of the use of counterweights in a limited way to provide this countervailing force, they are typically overlooked in favor of springs, which have the advantage of not adding substantial weight to the overall structure. Springs have some disadvantages, however:

1. The amount of force a spring exerts depends on the degree to which it is tensioned, such that the force/distance ratio changes as the angle of a joint is changed. This means that springs have a “sweet spot” (where the spring force exerted best approximates the gravity exerted) that occurs over a limited range.

2. Springs only counteract gravity in a single plane where the spring tension pulls up against gravity. As a sprung joint is rotated out of the vertical plane the force of gravity changes, but the spring force does not, resulting in an imbalance of forces. As a result, spring-powered joints must be kept oriented in one direction relative to gravity, severely limiting their potential range.

3. Because the counterforce provided by springs is approximate and variable depending on joint position, the joint itself must provide enough friction to satisfy the difference. For instance, if the joint position is at the edge or outside of the “sweet spot” of the spring, the joint must be tight enough that the joint still doesn't move on its own in response to too much gravity or too much spring tension pulling it one way or the other. This fights the objective for smooth and fluid motion by requiring that the joints be relatively tight, or that they be loosened and tightened every time the lamp position is adjusted.

4. Over time springs may change shape slightly and lose tension. They may also experience fatigue. The combined problems of creep and metal fatigue can lead to loss of performance or failure.

5. Springs can apply substantial forces to a joint, which must be accommodated by the joint design.

### SUMMARY OF THE INVENTION

Therefore, it is an objective of the present invention to provide a versatile positionable task lamp which is easy and convenient for the user to handle the position and the direction of the light to illuminate where the light is needed, and prevented from the disadvantages of the springs used in the conventional task lamp.

To attain the above objective, the present invention provides a versatile positionable task lamp comprising a base, first, second and third arms, first, second and third joints, a lighting element, and a plurality of counterweights. The first arm extends from the base and is rotatable about a first longitudinal axis thereof relative to the base. The first joint is fixed to the first arm. The second arm is connected with the first arm by the first joint which enables the second arm to rotate about a second longitudinal axis thereof and rotate about a first rotational axis of the first joint relative to the first arm. The second joint is fixed to the second arm. The third arm is connected with the second arm by the second joint which enables the third arm to rotate about a third longitudinal axis thereof and rotate about a second rotational axis of the second joint relative to the second arm. The third joint is fixed to the third arm. The lighting element is connected with the third arm by the third joint which enables the lighting element to rotate about a third rotational axis of the third joint relative to the third arm. The counterweights are disposed on the second arm and the third arm in a way that two masses respectively extending from two opposite sides of anyone of the first joint and the second joint are counterweighted by each other.

As a result, the task lamp of the present invention is capable of providing illumination in any direction from any point within a spherical space with radius equal to the lamp's fully extended boom. Because of the first to third joints connecting the lighting element and the first to third arms and the counterweights offsetting the weight of each segment of the task lamp, the lighting element can be easily and fluidly directed and yet stays where it is put.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIGS. 1 and 2 are assembled perspective views of a versatile positionable task lamp according to a first preferred embodiment of the present invention;

FIG. 3 is a front view of the versatile positionable task lamp;

FIG. 4 is a sectional view of the part A shown in FIG. 3;

FIG. 5 is an exploded perspective view showing a first arm, a first joint, a second arm and a first counterweight of the versatile positionable task lamp;

FIG. 6 is a sectional view of the part B shown in FIG. 3;

FIG. 7 is an exploded perspective view showing a second arm, a second joint, a third arm and a second counterweight of the versatile positionable task lamp;

FIG. 8 is a sectional view of the part C shown in FIG. 3;

FIG. 9 is an exploded perspective view showing a third arm, a third joint, a lighting element, a handle and a control panel of the versatile positionable task lamp;

FIG. 10 is an exploded perspective view of a member of a pivot;

FIG. 11 is a sectional view of the member of the pivot;

FIG. 12 is an assembled perspective view of a versatile positionable task lamp according to a second preferred embodiment of the present invention;

FIG. 13 is a partially enlarged view of FIG. 12;

FIGS. 14 and 15 are respectively an exploded perspective view and a sectional view of the part D shown in FIG. 12; and

FIGS. 16 and 17 are respectively an exploded perspective view and a sectional view of the part E shown in FIG. 12.

### DETAILED DESCRIPTION OF THE INVENTION

First of all, it is to be mentioned that same or similar reference numerals used in the following embodiments and the appendix drawings designate same or similar elements or the structural features thereof throughout the specification for the purpose of concise illustration of the present invention, and the features mentioned in each embodiment can be applied in the other embodiments if the application is possible in practice.

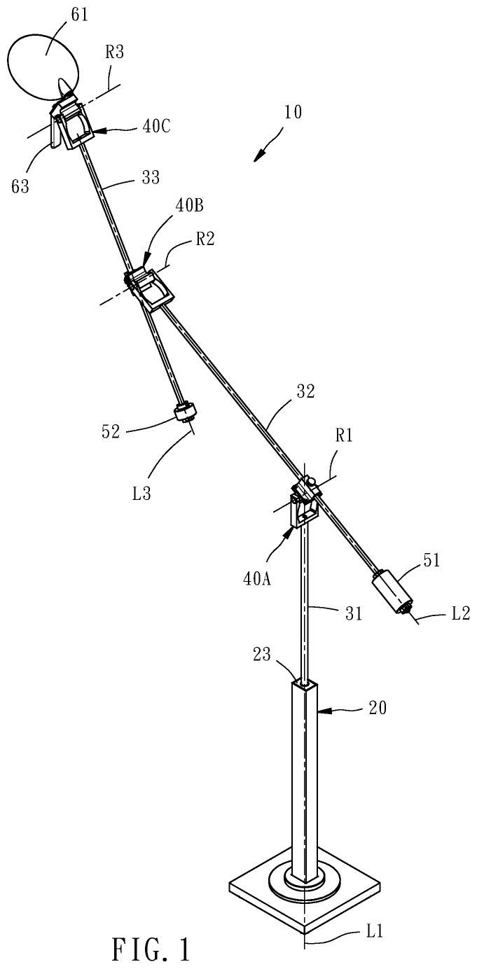

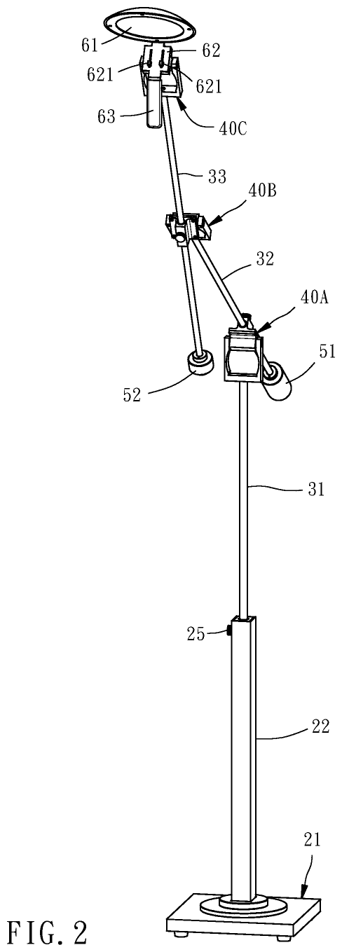

Referring to FIGS. 1-3, a versatile positionable task lamp 10 according to a first preferred embodiment of the present invention primarily includes a base 20, first to third arms 31-33, first to third joints 40A-C, first and second counterweights 51 and 52, and a lighting element 61.

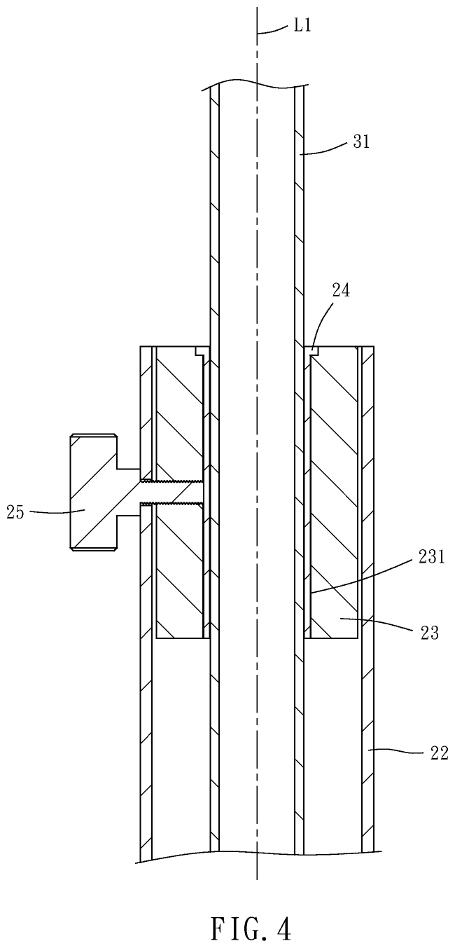

The base 20 includes a bottom seat 21, a rectangular tube 22 extending vertically and upwardly from the bottom seat 21, an installation block 23 disposed in the tube 22 at the top end thereof and fixed to the tube 22 by bolts (not shown), a bushing 24 (as shown in FIG. 4) disposed in a through hole 231 of the installation block 23, and a knob screw 25 inserted through the tube 22 and the installation block 23 and abutted against the outside of the bushing 24.

The first arm 31 is inserted through the bushing 24 of the base 20 so that a part of the first arm 31 is located inside the tube 22 of the base 20 and the other part of the first arm 31 extends vertically and upwardly from the top end of the base 20. Through the bushing 24 whose inside material is softer than the first arm 31, the first arm 31 is grasped by the base 20 and rotatable relative to the bushing 24 of the base 20. Specifically speaking, the first arm 31 is rotatable about a first longitudinal axis L1 thereof relative to the base 20. The knob screw 25 is adapted for the user to adjust the force of the base 20 grasping the first arm 31.

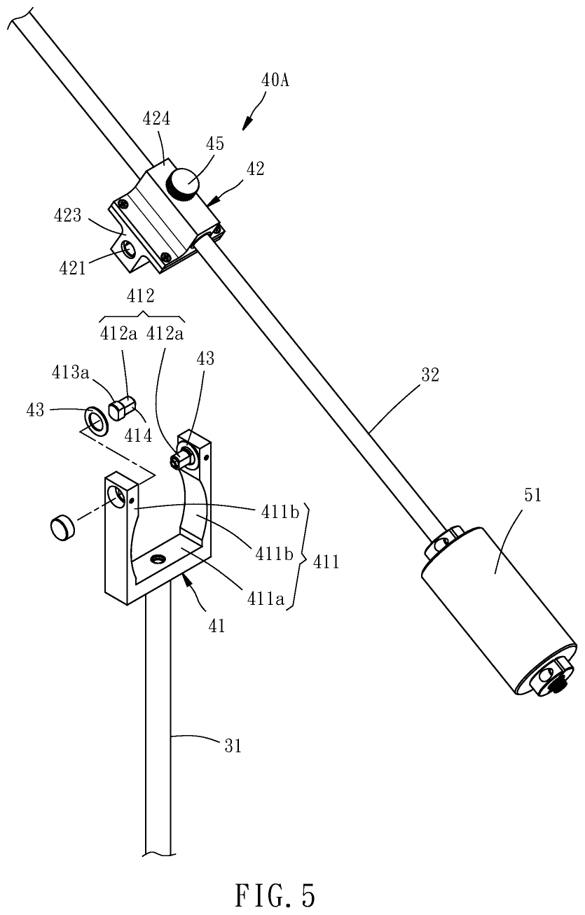

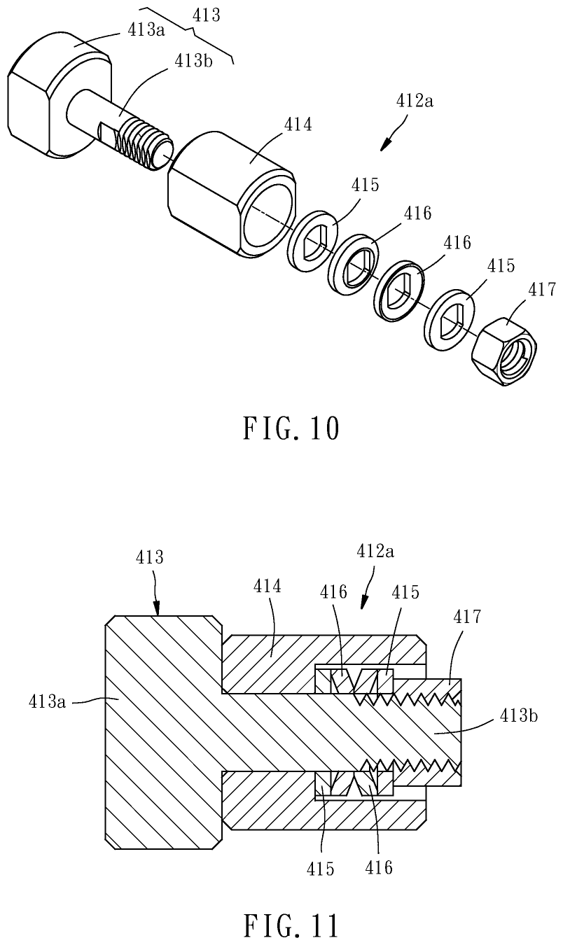

Referring to FIGS. 5-9, each of the first to third joints 40A-C includes a connecting member 41, an installation seat 42 and two spring washers 43. The connecting member 41 includes a main body 411 and a pivot 412. The main body 411 has a base portion 411a and two extending portions 411b extending from two ends of the base portion 411a respectively. The pivot 412 includes two members 412a as shown in FIGS. 10-11. Each member 412a of the pivot 412 includes a bolt 413 having a head portion 413a and a threaded rod 413b, a sleeve 414 rotatably sleeved onto the threaded rod 413b of the bolt 413, two washers 415 and two spring washers 416 sleeved onto the threaded rod 413b of the bolt 413 and located in the sleeve 414, and a nut 417 screwed onto the threaded rod 413b of the bolt 413 and abutted against one of the washers 415. By means of tightening or loosening the nut 417, the rotational resistance against the sleeve 414 can be adjusted. The head portions 413a of the two members 412a of the pivot 412 are fixedly inserted in the two extending portions 411b of the main body 411 respectively in a way that the sleeves 414 of the two members 412a of the pivot 412 face toward each other. The installation seat 42 is pivotably disposed on the connecting member 41 in a way that the sleeves 414 of the two members 412a of the pivot 412 are fixedly inserted into two ends of a through hole 421 of the installation seat 42. The two spring washers 43 are disposed between the main body 411 of the connecting member 41 and two sides of the installation seat 42.

Referring to FIGS. 5-8, for each of the first and second joints 40A-B, the installation seat 42 is composed of a first piece 423 having the aforesaid through hole 421 for accommodating the sleeves 414 of the two members 412a of the pivot 412, and a second piece 424 fixed to the first piece 423 by screws and having another through hole 425. Besides, each of the first and second joints 40A-B further includes two bushings 44 disposed in the through hole 425 and connected with each other, and a knob screw 45 inserted through the second piece 424 of the installation seat 42 and abutted against one of the bushings 44.

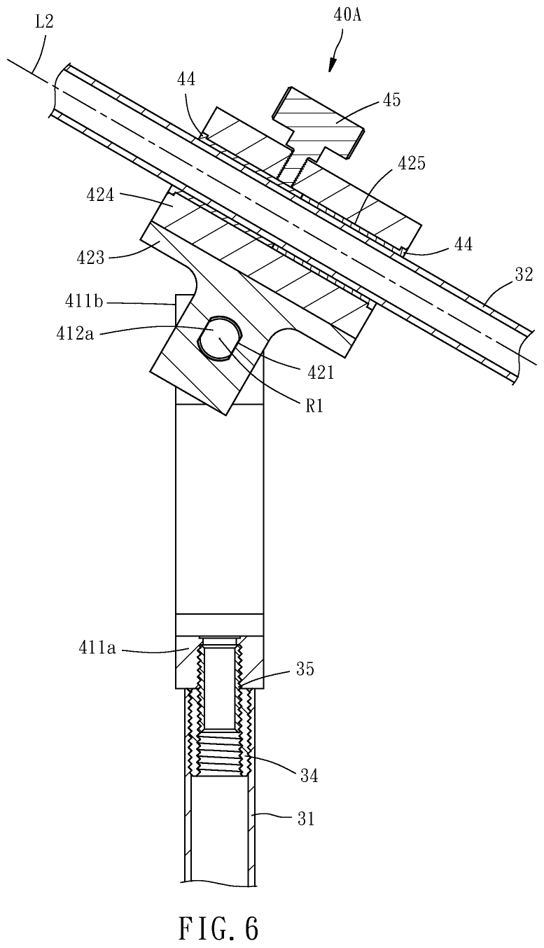

As to the first joint 40A as shown in FIGS. 5-6, the base portion 411a of the main body 411 of the connecting member 41 is fixed to an end of the first arm 31 by two bolts 34 and 35. The second arm 32 is connected with the first arm 31 by the first joint 40A in a way that the second arm 32 is inserted through the bushings 44 of the first joint 40A and rotatable relative to the bushings 44. Through the bushings 44 whose inside material is softer than the second arm 32, the second arm 32 is grasped by the first joint 40A and rotatable relative to the bushings 44 of the first joint 40A. Specifically speaking, the second arm 32 is rotatable about a second longitudinal axis L2 thereof relative to the first joint 40A. The knob screw 45 of the first joint 40A is adapted for the user to adjust the force of the first joint 40A grasping the second arm 32. Besides, the installation seat 42 is pivotably disposed on the connecting member 41, so the second arm 32 is also capable of rotating about a first rotational axis R1 (as shown in FIG. 1) of the pivot 412 of the first joint 40A relative to the first arm 31.

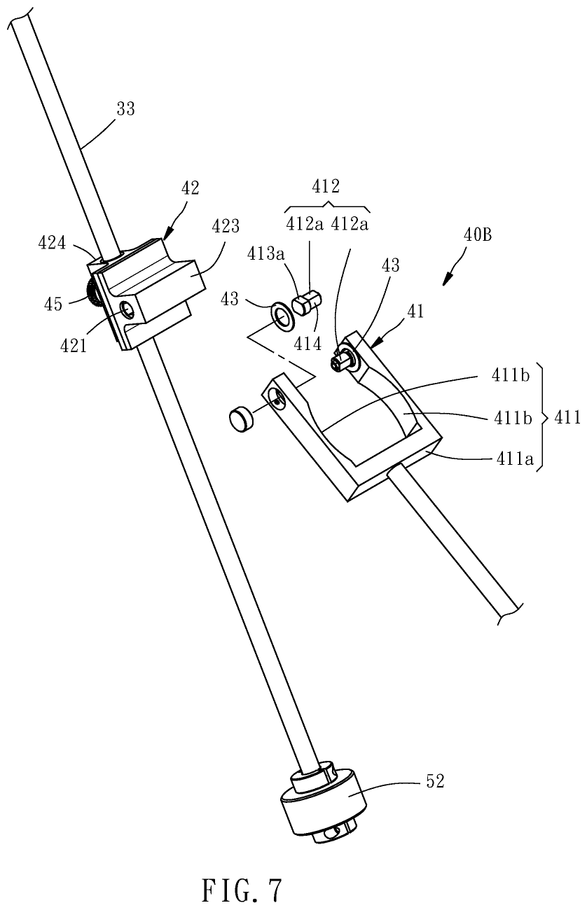

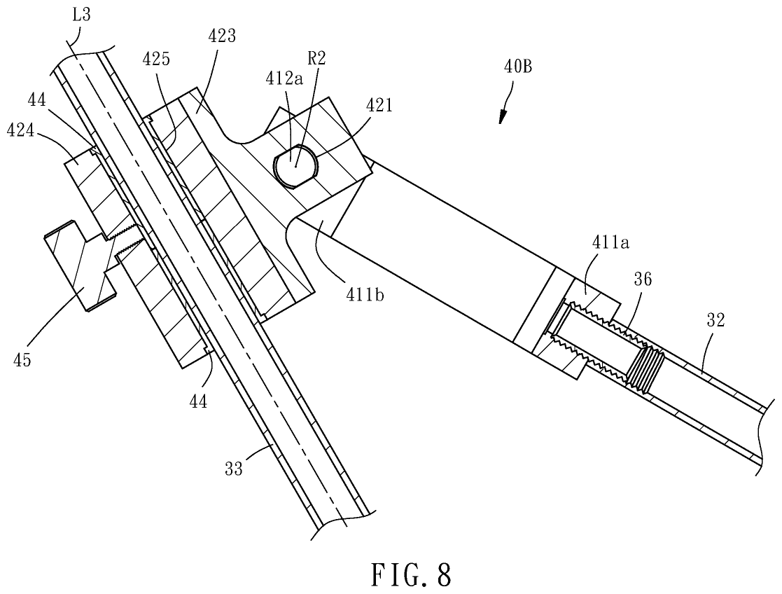

As to the second joint 40B as shown in FIGS. 7-8, the base portion 411a of the main body 411 of the connecting member 41 is fixed to an end of the second arm 32 by a bolt 36. The third arm 33 is connected with the second arm 32 by the second joint 40B in a way that the third arm 33 is inserted through the bushings 44 of the second joint 40B and rotatable relative to the bushings 44. Through the bushings 44 whose inside material is softer than the third arm 33, the third arm 33 is grasped by the second joint 40B and rotatable relative to the bushings 44 of the second joint 40B. Specifically speaking, the third arm 33 is rotatable about a third longitudinal axis L3 thereof relative to the second joint 40B. The knob screw 45 of the second joint 40B is adapted for the user to adjust the force of the second joint 40B grasping the third arm 33. Besides, the installation seat 42 is pivotably disposed on the connecting member 41, so the third arm 33 is also capable of rotating about a second rotational axis R2 (as shown in FIG. 1) of the pivot 412 of the second joint 40B relative to the second arm 32.

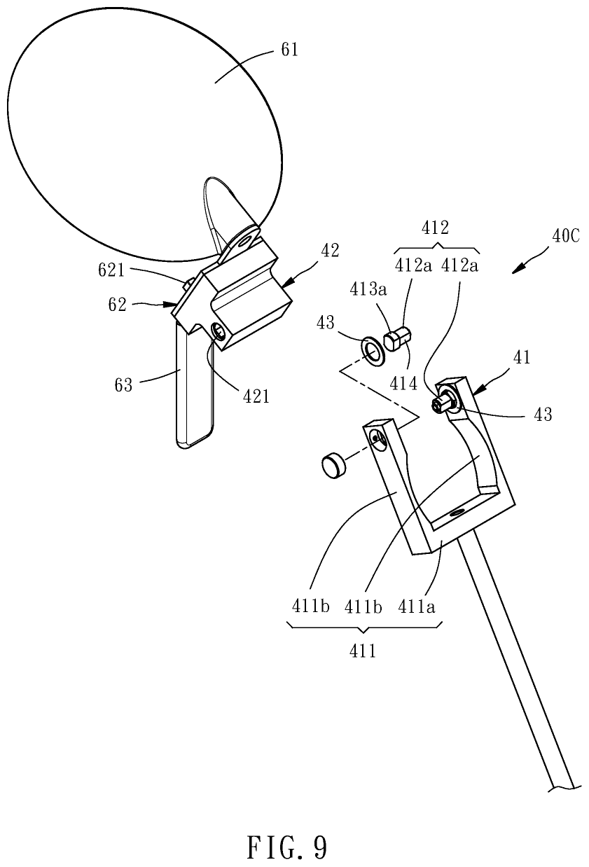

As to the third joint 40C as shown in FIG. 9, the base portion 411a of the main body 411 of the connecting member 41 is fixed to an end of the third arm 33 by a bolt (not shown). The lighting element 61 is fixed on the installation seat 42 of the third joint 40C, thereby capable of rotating about a third rotational axis R3 (as shown in FIG. 1) of the pivot 412 of the third joint 40C relative to the third arm 33. In addition, the installation seat 42 of the third joint 40C is provided thereon with a control panel 62 and a handle 63. The control panel 62 is fixed on the installation seat 42 of the third joint 40C and provided with two sliding switches 621 for electrically controlling the lighting element 61, such as controlling the light level and color temperature. The lighting element 61 and the handle 63 extend from two opposite sides of the control panel 62. The lighting element 61 and the handle 63 are counterweighted by each other, so they can stay whichever angle they are turned about the third rotational axis R3 and turned about the third longitudinal axis L3 along with the third arm 33.

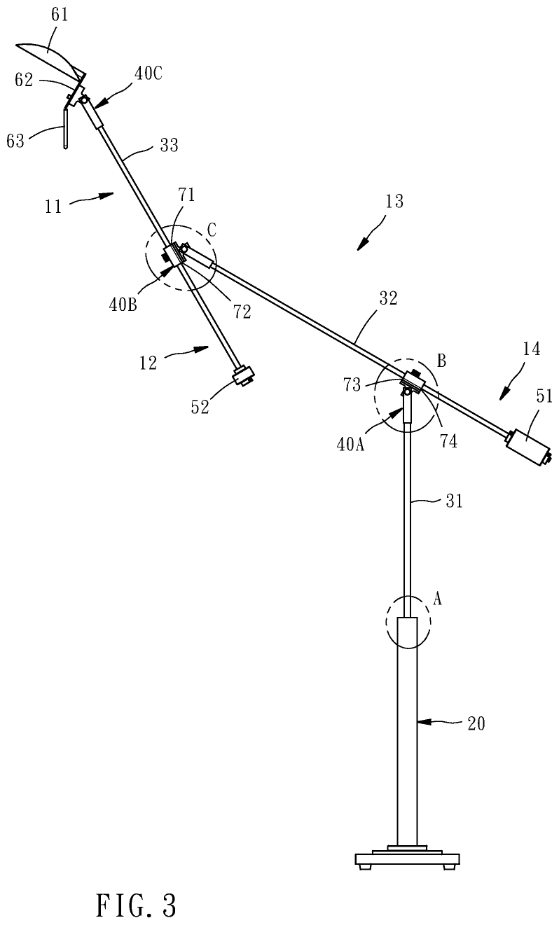

Referring to FIG. 3, the second counterweight 52 is disposed on the third arm 33 in a way that the third joint 40C and the second counterweight 52 are located at two opposite ends of the third arm 33 respectively. The mass 11 extending from a front side 71 of the second joint 40B, including the lighting element 61, the control panel 62, the handle 63, the third joint 40C and a part of the third arm 33, is counterweighted by the mass 12 extending from a rear side 72 of the second joint 40B, including the other part of the third arm 33 and the second counterweight 52. Therefore, the third arm 33 can stay whichever angle it is turned about the second rotational axis R2 and turned about the second longitudinal axis L2 along with the second arm 32. The first counterweight 51 is disposed on the second arm 32 in a way that the second joint 40B and the first counterweight 51 are located at two opposite ends of the second arm 32 respectively. The mass 13 extending from a front side 73 of the first joint 40A, including the masses 11 and 12, the second joint 40B and a part of the second arm 32, is counterweighted by the mass 14 extending from a rear side 74 of the first joint 40A, including the other part of the second arm 32 and the first counterweight 51. Therefore, the second arm 32 can stay whichever angle it is turned about the first rotational axis R1 and turned about the first longitudinal axis L1 along with the first arm 31.

It can be known from the above description and the figures that the base 20 and the first arm 31 provide a vertical support supporting an articulated boom, at the end of which perches the light. The vertical support may be telescopic to afford height adjustment. That means the part of the first arm 31 extending out of the base 20 is adjustable in length thereof The boom is provided with six axes of articulation by three joints 40A-C, or “knuckles.” The first joint 40A provides three axes of rotation, L1, R1 and L2. The second joint 40B provides two axes of rotation, R2 and L3. The third joint 40C provides an axis of rotation, R3. Each joint adds one less new axis of motion than the one before, resulting in a triangular distribution of axes, 3-2-1, that maximizes the efficiency of axis distribution.

Every mass extended from a knuckle is counterweighted by an equivalent mass extended in the opposite direction. Thus, the lighting element 61 is counterweighted by the handle 63, the mass 11 is counterweighted across the second joint 40B by the mass 12 including a steel counterweight 52 on the other side, and the mass 13 including the masses 11 and 12 is counterweighted across the first joint 40A by the mass 14 including an even bigger counterweight 51 on the other side. This arrangement allows for nearly effortless liquidity of motion as one adjusts the lighting element 61 from one position to another.

Often in lighting, springs are used to help counterbalance arm forces. Though they can be useful when the range of motion is limited, their distance/force ratios change at a different rate than the moment arms they are engaged to counter. Because counterweights' moments are always changing at the same rate as their partners, they are tuned precisely at every position along the full range of motion of their arms. Although this adds in overall weight, what is gained is a sensually rewarding liquidity of motion and precision in position-ability. No more “sweet spots,” outside of which performance falls off exponentially. Also, other problems associated with springs are avoided, such as spring fatigue, added forces and potential sources of friction.

The first and second joints 40A and 40B grasp the second and third arms 32 and 33 with an adjustable amount of force. The riding surface on the inside of the bushings 44 of the first and second joints 40A and 40B is of a softer material than the arms 32 and 33 to facilitate lubricity. The combination of a lubricious surface interface and adjustable grasping force allows the joints 40A and 40B to be tuned such that they stay where they are put, but are still nearly effortless to move. Tension is adjusted with knob screws 45 to suit one's needs, but even with very little tension the arms 32 and 33 will keep their position because of the counterweights 51 and 52.

As a result, the task lamp 10 of the present invention is an articulated task lamp that offers a lighting element 61 at the end of an easily positionable counterweighted articulated boom that stays where it is moved. With one hand, one can easily position the lighting element 61 anywhere within the spherical radius of its range and with the thumb can control light level and color temperature. The lighting element 61 can be pointed in any direction from any point within a sphere with a radius equal to the fully extended boom. The handle 63 and the control panel 62 are provided together with the lighting element 61 for easy positioning and for control of electronic functions. The handle 63 and lighting element 61 perch at the end of a boom composed of several segments connected via tensioned universal joints 40A-C, or “knuckles.” The weight of each segment is offset by a counterweight on the segment before, resulting in a zero-gravity experience in positioning the light. The two main elements that distinguish the invention from other lamps in its class are its joints of articulation and its counterweights.

Therefore, the present invention combines the elements of comfort, convenience and ease of use in a single, visually appealing task lamp 10 that can be adapted to many application environments. Those applications, for example, may include reading, sewing, photography, decorative lighting, ambient illumination, etc. The task lamp 10 presents a versatile solution that can be scaled to fit different environments, from ceiling mount to floor lamp to desk lamp.

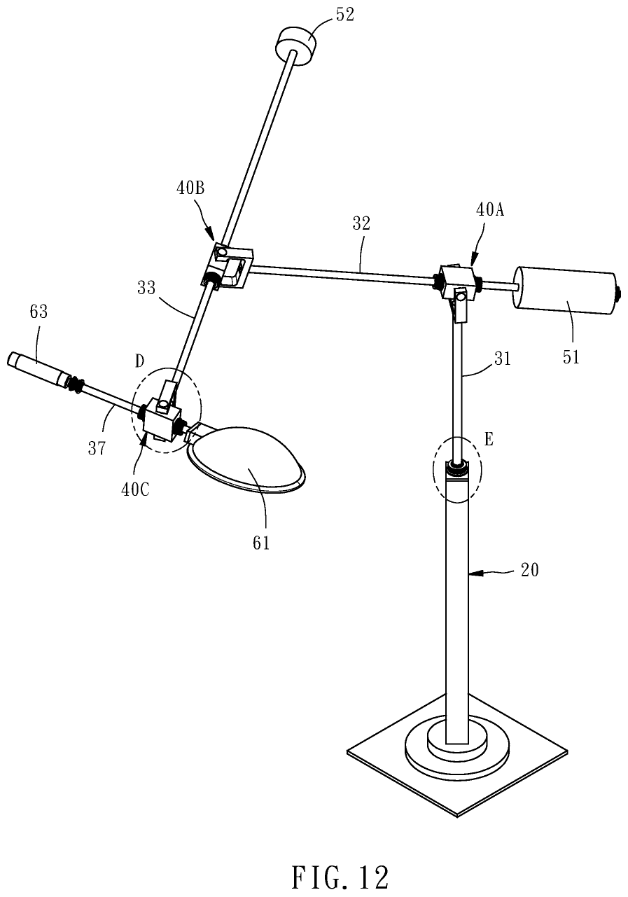

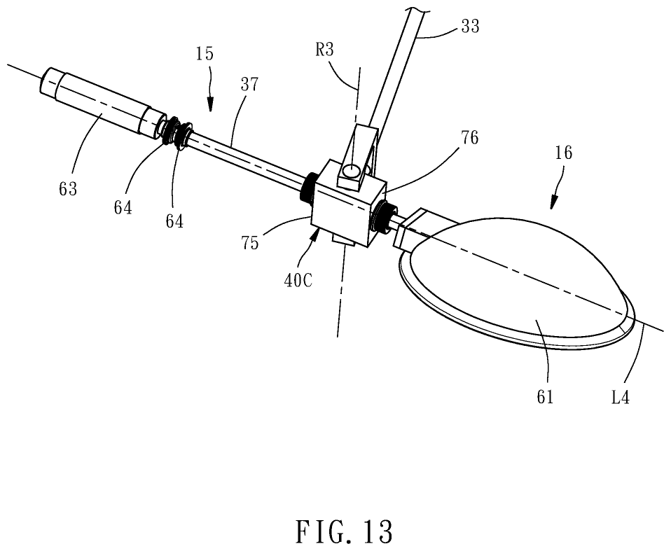

A second preferred embodiment of the present invention is shown in FIGS. 12-17. It will be appreciated that the lighting element 61 and the handle 63 of the versatile positionable task lamp of the present invention may be disposed on a fourth arm 37 which is connected with the third arm 33 by the third joint 40C and rotatable about its own axis relative to the third joint 40C, as shown in this embodiment. That means the lighting element 61 and the handle 63 are connected with the third arm 33 through the fourth arm 37 and the third joint 40C, and the lighting element 61 and the handle 63 are rotatable along with the fourth arm 37 relative to the third arm 33 about not only the third rotational axis R3 of the third joint 40C but also a fourth longitudinal axis L4 of the fourth arm 37 as shown in FIG. 13. Besides, the lighting element 61 and the handle 63 are located by the left side 75 and the right side 76 of the third joint 40C respectively in a way that the mass 15 extending from the left side 75 of the third joint 40C, including the handle 63 and a part of the fourth arm 37, is counterweighted by the mass 16 extending from the right side 76 of the third joint 40C, including the other part of the fourth arm 37 and the lighting element 61. In this way, it is relatively more convenient for the user to adjust the angel of the lighting element 61. In addition, there are two control wheels 64 disposed on the fourth arm 37 for providing similar function with the aforesaid control panel 62 to electrically control the lighting element 61, such as controlling its light level and color temperature.

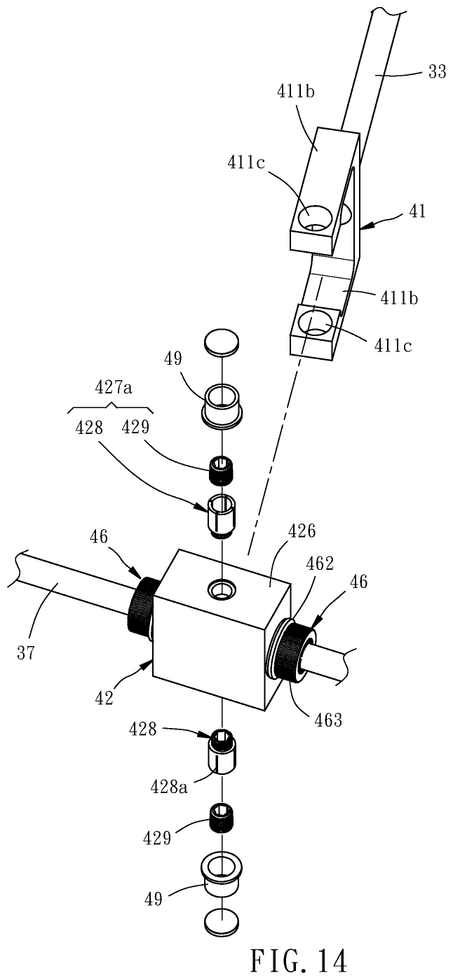

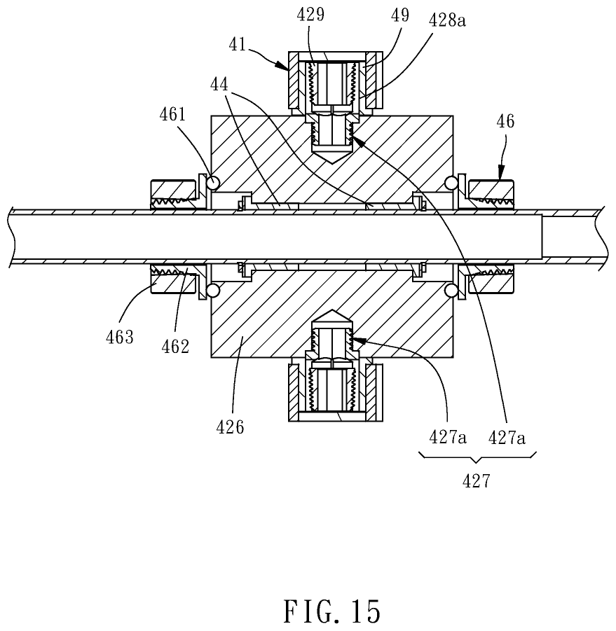

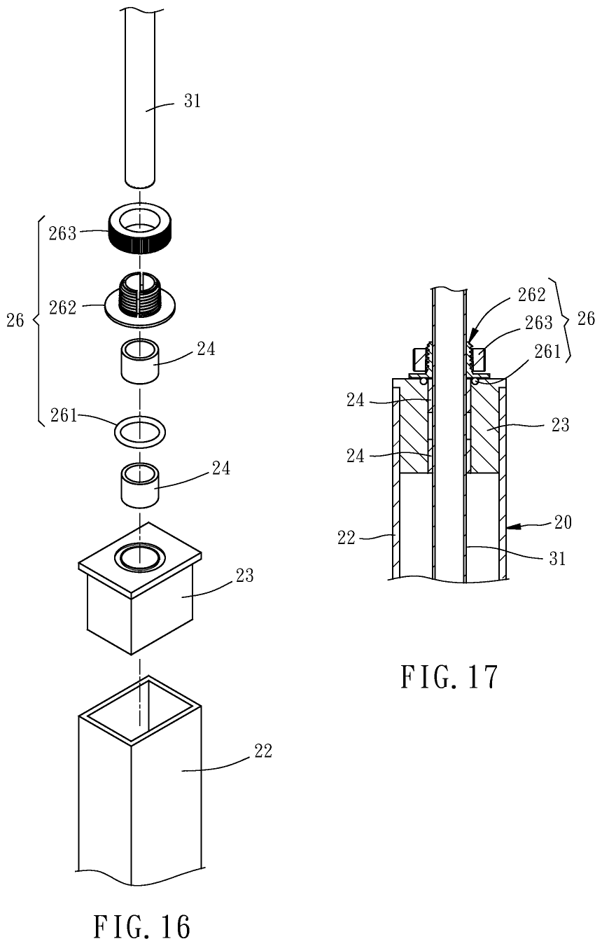

The structure of the joints used in this embodiment is a little different from that used in the first preferred embodiment. The first to third joints 40A-C in this embodiment have the same structure, so the detail of the joints in this embodiment is specified hereinunder by taking only the third joint 40C as an example with reference to FIGS. 14 and 15. In addition to the connecting member 41, the installation seat 42 and the bushings 44 as described above, each of the joints 40A-C in this embodiment further includes two clamp units 46 sleeved onto the arm grasped by the associated joint and located on two opposite sides of the installation seat 42. For example, the clamp units 46 of the third joint 40C are sleeved on the fourth arm 37. Each clamp unit 46 includes an elastic ring (e.g. O-ring) 461, an elastic clamp 462 and a clamp nut 463. The elastic clamp 462 is provided with four open slits like the elastic clamp 262 shown in FIG. 16, and the outer surface of the elastic clamp 462 is slightly tapered and provided with threads. Therefore, the clamp nuts 463 can be screwed onto the elastic clamps 462 to make the elastic clamps 462 clamp the arm inserted therethrough and abut against the installation seat 42 via the elastic rings 461. The clamp nuts 463 can be rotated to adjust the force of the associated joint grasping the arm. For example, the clamp nuts 463 of the third joint 40C can be rotated to adjust the force of the third joint 40C grasping the fourth arm 37.

As shown in FIGS. 16 and 17, the base 20 in this embodiment also includes a clamp unit 26 sleeved onto the first arm 31 and located at the top end of the installation block 23. The clamp unit 26 includes an elastic ring (e.g. O-ring) 261, an elastic clamp 262 and a clamp nut 263. The elastic clamp 262 is provided with four open slits, and the outer surface of the elastic clamp 262 is slightly tapered and provided with threads. Therefore, the clamp nut 263 can be screwed onto the elastic clamp 262 to make the elastic clamp262 clamp the first arm 31 and abut against the installation block 23 via the elastic ring 261. The clamp nut 263 can be rotated to adjust the force of the base 20 grasping the first arm 31.

As shown in FIGS. 14 and 15, the pivots of the joints in this embodiment are also structurally different from that disclosed in the first preferred embodiment. In this embodiment, the installation seat 42 of each of the first to third joints 40A-C includes a main body 426 for the associated arm to be inserted therethrough and a pivot 427 fixed to the main body 426. For example, the fourth arm 37 is inserted through the main body 426 of the installation seat 42 of the third joint 40C. The pivot 427 includes two members 427a coaxially located on two opposite sides of the main body 426 respectively. Each member 427a includes a fixed element 428 and an adjusting element 429. The fixed element 428 is screwed into the main body 426 and has an elastic clamp portion 428a protruding out of the main body 426. The inner surface of the elastic clamp portion 428a is slightly tapered and provided with threads. The adjusting member 429 is screwed into the elastic clamp portion 428a. Besides, each of the joints 40A-C includes two bushings 49 fixed in through holes 411c of the two extending portions 411b of the connecting member 41, respectively. The two elastic clamp portions 428a of the pivot 427 are respectively inserted into the two through holes 411c of the connecting member 41 in a way that the two bushings 49 are sleeved onto the two elastic clamp portions 428a and located between the elastic clamp portions 428a and the connecting member 41. The elastic clamp portion 428a is provided with four open slits, so the adjusting member 429 can be rotated to elastically expand out or release the elastic clamp portion 428a to adjust the rotational resistance against the pivot 427 when the pivot 427 is rotated relative to the bushings 49.The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A versatile positionable task lamp comprising:
a base;
a first arm extending from the base and rotatable about a first longitudinal axis thereof relative to the base;
a first joint fixed to the first arm;
a second arm connected with the first arm by the first joint which enables the second arm to rotate about a second longitudinal axis thereof and rotate about a first rotational axis of the first joint relative to the first arm;
a second joint fixed to the second arm;
a third arm connected with the second arm by the second joint which enables the third arm to rotate about a third longitudinal axis thereof and rotate about a second rotational axis of the second joint relative to the second arm;
a third joint fixed to the third arm;
a lighting element connected with the third arm by the third joint which enables the lighting element to rotate about a third rotational axis of the third joint relative to the third arm; and
a plurality of counterweights disposed on the second arm and the third arm in a way that two masses respectively extending from two opposite sides of anyone of the first joint and the second joint are counterweighted by each other.

2. The versatile positionable task lamp as claimed in claim 1, wherein the plurality of counterweights comprises a first counterweight disposed on the second arm and a second counterweight disposed on the third arm; the second joint and the first counterweight are located at two opposite ends of the second arm respectively; the third joint and the second counterweight are located at two opposite ends of the third arm respectively.

3. The versatile positionable task lamp as claimed in claim 1, wherein the lighting element is disposed on a side of the third joint and counterweighted by a handle disposed on another side of the third joint.

4. The versatile positionable task lamp as claimed in claim 3, wherein the third joint comprises a connecting member fixed to the third arm and an installation seat pivotably disposed on the connecting member; the lighting element and the handle are fixed on the installation seat.

5. The versatile positionable task lamp as claimed in claim 4, wherein the installation seat is provided thereon with a control panel for electrically controlling the lighting element.

6. The versatile positionable task lamp as claimed in claim 1, wherein the second joint comprises a connecting member fixed to the second arm, an installation seat pivotably disposed on the connecting member and provided with a through hole, and a bushing disposed in the through hole; the third arm is inserted through the bushing and rotatable relative to the bushing.

7. The versatile positionable task lamp as claimed in claim 6, wherein the second joint comprises a knob screw inserted through the installation seat and abutted against the bushing for adjusting a force of the second joint grasping the third arm.

8. The versatile positionable task lamp as claimed in claim 6, wherein the second joint comprises two clamp units sleeved onto the third arm and located on two sides of the installation seat respectively; each of the clamp units comprises an elastic ring, an elastic clamp and a clamp nut screwed onto the elastic clamp to make the elastic clamp clamp the third arm and abut against the installation seat via the elastic ring.

9. The versatile positionable task lamp as claimed in claim 6, wherein the connecting member comprises a main body and a pivot fixed to the main body and inserted in the installation seat; the second joint comprises two spring washers disposed between the main body of the connecting member and two sides of the installation seat.

10. The versatile positionable task lamp as claimed in claim 6, wherein the installation seat comprises a main body and a pivot fixed to the main body and inserted into the connecting member; the pivot comprises two elastic clamp portions located on two sides of the main body respectively and two adjusting elements screwed into the two elastic clamp portions respectively; the second joint comprises two other bushings sleeved onto the two elastic clamp portions respectively and located between the elastic clamp portions and the connecting member.

11. The versatile positionable task lamp as claimed in claim 1, wherein the first joint comprises a connecting member fixed to the first arm, an installation seat pivotably disposed on the connecting member and provided with a through hole, and a bushing disposed in the through hole; the second arm is inserted through the bushing and rotatable relative to the bushing.

12. The versatile positionable task lamp as claimed in claim 11, wherein the first joint comprises a knob screw inserted through the installation seat and abutted against the bushing for adjusting a force of the first joint grasping the second arm.

13. The versatile positionable task lamp as claimed in claim 11, wherein the first joint comprises two clamp units sleeved onto the second arm and located on two sides of the installation seat respectively; each of the clamp units comprises an elastic ring, an elastic clamp and a clamp nut screwed onto the elastic clamp to make the elastic clamp clamp the second arm and abut against the installation seat via the elastic ring.

14. The versatile positionable task lamp as claimed in claim 11, wherein the connecting member comprises a main body and a pivot fixed to the main body and inserted in the installation seat; the first joint comprises two spring washers disposed between the main body of the connecting member and two sides of the installation seat.

15. The versatile positionable task lamp as claimed in claim 11, wherein the installation seat comprises a main body and a pivot fixed to the main body and inserted into the connecting member; the pivot comprises two elastic clamp portions located on two sides of the main body respectively and two adjusting elements screwed into the two elastic clamp portions respectively; the first joint comprises two other bushings sleeved onto the two elastic clamp portions respectively and located between the elastic clamp portions and the connecting member.

16. The versatile positionable task lamp as claimed in claim 1, wherein the base comprises a tube, an installation block fixedly disposed in the tube and provided with a through hole, and a bushing disposed in the through hole; the first arm is inserted through the bushing and rotatable relative to the bushing; the base comprises a knob screw inserted through the tube and the installation block and abutted against the bushing for adjusting a force of the base grasping the first arm.

17. The versatile positionable task lamp as claimed in claim 1, wherein the base comprises a tube, an installation block fixedly disposed in the tube and provided with a through hole, and a bushing disposed in the through hole; the first arm is inserted through the bushing and rotatable relative to the bushing; the base comprises a clamp unit sleeved onto the first arm and located at an end of the installation block; the clamp unit comprises an elastic ring, an elastic clamp and a clamp nut screwed onto the elastic clamp to make the elastic clamp clamp the first arm and abut against the installation block via the elastic ring.

18. The versatile positionable task lamp as claimed in claim 1, further comprising a fourth arm and a handle; the fourth arm is connected with the third arm by the third joint in a way that the fourth arm is rotatable about a fourth longitudinal axis thereof and about the third rotational axis of the third joint relative to the third arm; the lighting element and the handle are disposed on the fourth arm and located by two opposite sides of the third joint respectively in a way that two masses respectively extending from the two opposite sides of the third joint are counterweighted by each other.

19. The versatile positionable task lamp as claimed in claim 18, wherein the third joint comprises a connecting member fixed to the third arm, an installation seat pivotably disposed on the connecting member and provided with a through hole, and a bushing disposed in the through hole; the fourth arm is inserted through the bushing and rotatable relative to the bushing; the third joint comprises two clamp units sleeved onto the fourth arm and located on two sides of the installation seat respectively; each of the clamp units comprises an elastic ring, an elastic clamp and a clamp nut screwed onto the elastic clamp to make the elastic clamp clamp the fourth arm and abut against the installation seat via the elastic ring.

20. The versatile positionable task lamp as claimed in claim 18, wherein the third joint comprises a connecting member fixed to the third arm, an installation seat pivotably disposed on the connecting member and provided with a through hole, and a bushing disposed in the through hole; the fourth arm is inserted through the bushing and rotatable relative to the bushing; the installation seat comprises a main body and a pivot fixed to the main body and inserted into the connecting member; the pivot comprises two elastic clamp portions located on two sides of the main body respectively and two adjusting elements screwed into the two elastic clamp portions respectively; the third joint comprises two other bushings sleeved onto the two elastic clamp portions respectively and located between the elastic clamp portions and the connecting member.
